(19) United States
(12) Patent Application Publication
(10) Pub. No.: US 2006/0070061 A1
(43) Pub. Date: Mar. 30, 2006

(54) Allowing multiple decisions to be made by multiple decision makers during software installation

(75) Inventors: David E. Cox, Raleigh, NC (US); Craig M. Lawton, Raleigh, NC (US); Jonathan A. Lewis, Morrisville, NC (US); Christopher A. Peters, Round Rock, TX (US); Lorin E. Ullmann, Austin, TX (US)

Correspondence Address: IBM CORP (WSM);C/O WINSTEAD SECHREST & MINICK P.C., PO BOX 50784, DALLAS, TX, 75201, US

(73) Assignee: International Business Machines Corporation, Armonk, NY (US)

(21) Appl. No.: 10/955,200

(22) Filed: Sep. 30, 2004

(51) Int. Cl. G06F 9/445

(52) U.S. Cl. 717/174

(57) ABSTRACT

A method, computer program product and system for allowing multiple decisions to be made by multiple decision makers during software installation. A developer of an installer program may select the decisions to be made during the installation process. The developer may further designate the decision makers to handle each of these decisions in a configuration file. The configuration file may be compiled into executable code where the executable code may be embedded in the installer program. By the developer designating multiple decision makers to handle multiple decisions, multiple decision makers may now be able to be involved during the software installation process.

### TECHNICAL FIELD

The present invention relates to the field of installation programs, and more particularly to allowing multiple decisions to be made by multiple decision makers during software installation.

### BACKGROUND INFORMATION

An installer program is a software program that enables a programmer to write specific code to install a given application program onto the drives of a computer in a way that enables the given application program to work correctly with the computer's environment, including its operating system. There are several types of installers, such as Java installers and operating system specific installers, e.g., Microsoft Windows installers, International Business Machine's (“IBM's”) OS/2 and AIX operating system installers.

During the installation of an application program, the installer program may simply perform what is referred to as a “silent install.” A silent install may refer to the installer program installing the application program without presenting any Graphical User Interface (GUI) images to the user containing questions relating to the installation process.

In other cases, the installer program may provide the user (individual running the installer program) with a choice of multiple types of installation processes, e.g., typical or advanced, where the user may be presented with a different number of questions on a GUI relating to the installation during the installation process.

In either case, the user is typically the sole individual responsible for performing the installation. For example, in the case of the installer program presenting questions during installation, an administrator cannot answer selected questions and then delegate the remaining questions to another user. There are situations where multiple decision makers may be required in order to install the application or to make better informed decisions, e.g., when asked a question that another user may be more knowledgeable to address.

For example, in certain environments, such as an enterprise with multiple computer systems and networks of different types, a single individual, e.g., database administrator, may not have access to information, e.g., user names and passwords in payroll, that may be necessary in order to install the application, e.g., payroll application. In such a case, the application may not be installed.

In another example, a single individual, e.g., administrator, may want to add software to be stored in a container (referring to software that acts as a parent program to hold and execute a set of commands or to run other software routines) in an application server. However, the individual needs approval from the administrator of the application server to load an application onto the application server. Hence, another decision maker may be required for the installation process.

In another example, the installer program may require particular software, e.g., database program, in order to complete the installation. The user, e.g., administrator, may receive a prompt requesting that the user provide such software. However, if the user cannot provide such software, then the installation cannot be completed. Hence, another decision maker, which may include software, may be required for the installation process.

Therefore, there is a need in the art for allowing multiple decisions to be made by multiple decision makers during software installation.

### SUMMARY

The problems outlined above may at least in part be solved in some embodiments by having the developer of the installer program select the decisions, e.g., determine where the install files are to be located, to be made during the installation process. The developer may further designate the decision makers, e.g., users, software, installer program, to handle each of these decisions in a configuration file. The configuration file may then be compiled into executed code where the executable code may be embedded in the installer program. By the developer designating multiple decision makers to handle multiple decisions, multiple decision makers may now be able to be involved during the software installation process.

In one embodiment of the present invention, a method for allowing multiple decisions to be made by multiple decision makers during software installation may comprise the step of selecting decisions to be made during the installation process. The method may further comprise designating decision makers for each selected decision in a configuration file. The method may further comprise compiling the configuration file into executable code. The method may further comprise embedding the executable code into an installer program.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates an embodiment of the present invention of a computer system;

FIG. 2 illustrates an embodiment of the present invention of software components of an installer program; and

FIG. 3 is a flowchart of a method for allowing multiple decisions to be made by multiple decision makers during software installation in accordance with an embodiment of the present invention.

### DETAILED DESCRIPTION

The present invention comprises a method, computer program product and system for allowing multiple decisions to be made by multiple decision makers during software installation. In one embodiment of the present invention, a developer of an installer program may select the decisions to be made during the installation process. The developer may further designate the decision makers to handle each of these decisions in a configuration file. The configuration file may be compiled into executable code where the executable code may be embedded in the installer program. By the developer designating multiple decision makers to handle multiple decisions, multiple decision makers may now be able to be involved during the software installation process.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

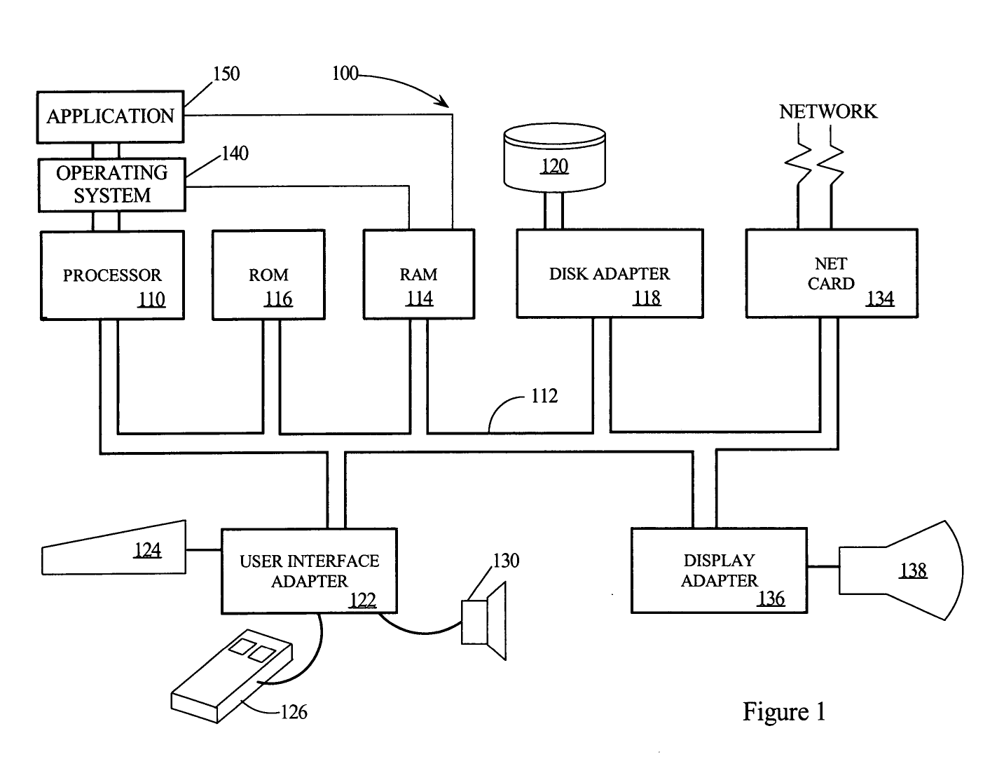

FIG. 1—Computer System

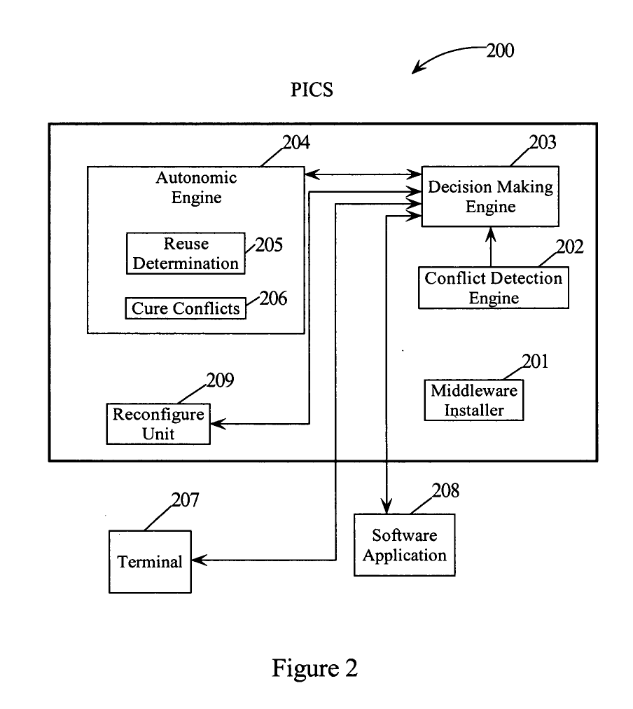

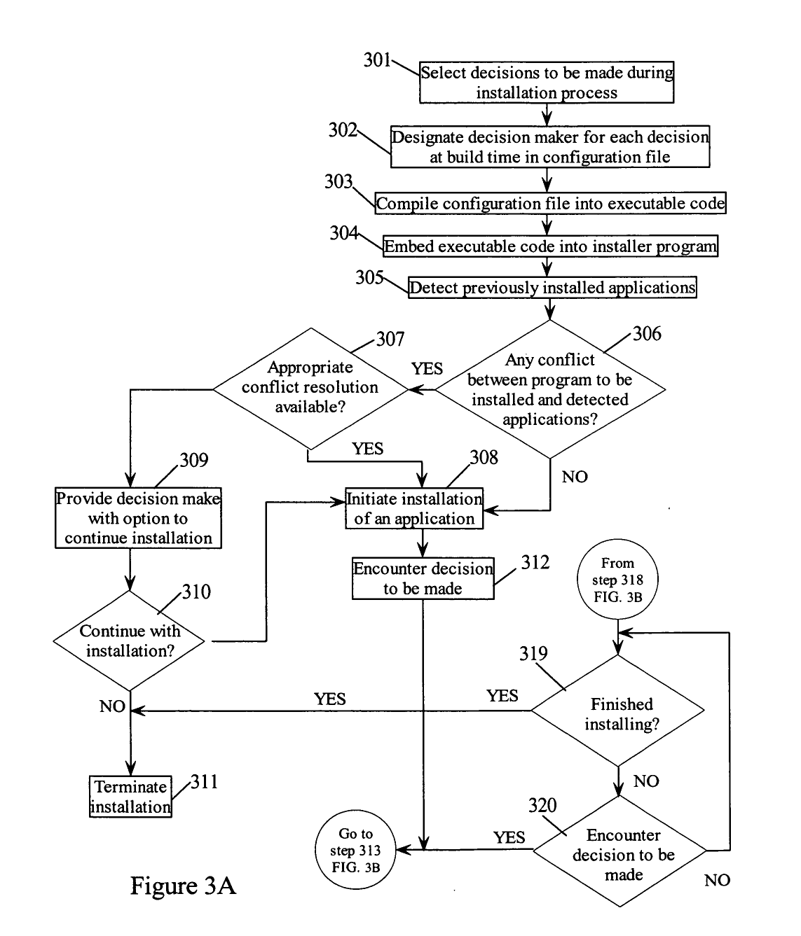

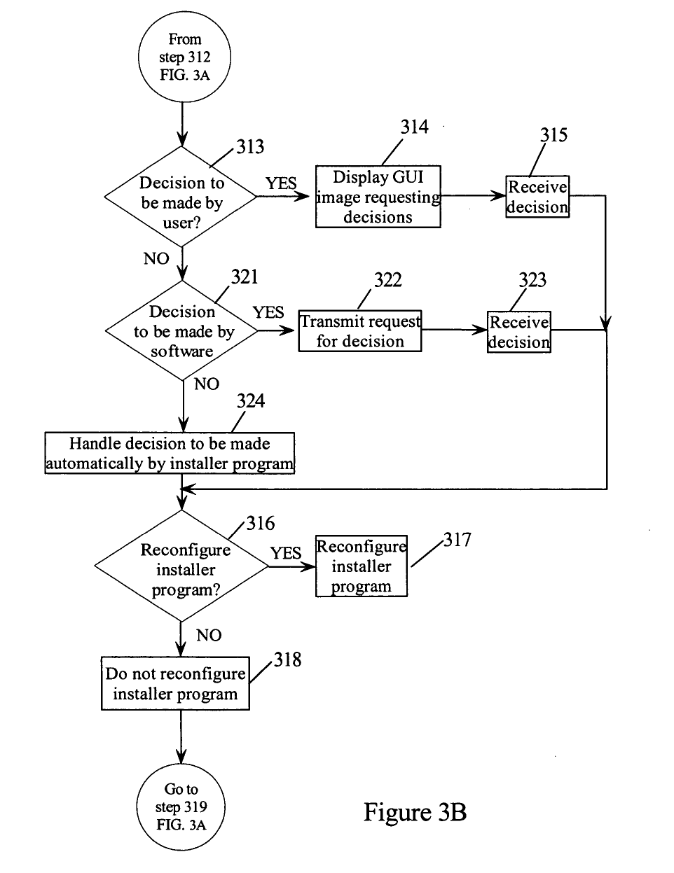

FIG. 1 illustrates a typical hardware configuration of computer system 100 which is representative of a hardware environment for practicing the present invention. Computer system 100 may have a processor 110 coupled to various other components by system bus 112. An operating system 140 may run on processor 110 and provide control and coordinate the functions of the various components of FIG. 1. An application 150 in accordance with the principles of the present invention may run in conjunction with operating system 140 and provide calls to operating system 140 where the calls implement the various functions or services to be performed by application 150. Application 150 may include, for example, an installer program, e.g., Platform Installation and Configuration Service (PICS), as well as executable code embedded in the installer program that contains the designated decision makers for each decision to be made during the installation process as discussed further below in association with FIGS. 2-3. A more detail description of the software components of the installer program is provided below in association with FIG. 2. FIG. 3 is a flowchart of a method for allowing multiple decisions to be made by multiple decision makers during the software installation process.

Read-Only Memory (ROM) 116 may be coupled to system bus 112 and include a basic input/output system (“BIOS”) that controls certain basic functions of computer system 100. Random access memory (RAM) 114 and disk adapter 118 may also be coupled to system bus 112. It should be noted that software components including operating system 140 and application 150 may be loaded into RAM 114 which may be computer system's 100 main memory for execution. Disk adapter 118 may be an integrated drive electronics (“IDE”) adapter that communicates with a disk unit 120, e.g., disk drive. It is noted that the installer program with embedded executable code that contains the designated decision makers for each decision to be made during the installation process, as discussed in association with FIGS. 2-3, may reside in disk unit 120 or in application 150.

Referring to FIG. 1, computer system 100 may further comprise a network card 134 coupled to bus 112. Network card 134 may interconnect bus 112 with an outside network, e.g., Local Area Network (LAN), Wide Area Network (WAN), enabling computer system 100 to communicate with other such systems. I/O devices may also be connected to system bus 112 via a user interface adapter 122 and a display adapter 136. Keyboard 124, mouse 126 and speaker 130 may all be interconnected to bus 112 through user interface adapter 122. Data may be inputted to computer system 100 through any of these devices. A display monitor 138 may be connected to system bus 112 by display adapter 136. In this manner, a user is capable of inputting to computer system 100 through keyboard 124 or mouse 126 and receiving output from computer system 100 via display 138 or speaker 130.

Implementations of the invention include implementations as a computer system programmed to execute the method or methods described herein, and as a computer program product. According to the computer system implementations, sets of instructions for executing the method or methods may be resident in the random access memory 114 of one or more computer systems configured generally as described above. Until required by computer system 100, the set of instructions may be stored as a computer program product in another computer memory, for example, in disk unit 120. Furthermore, the computer program product may also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

FIG. 2—Installer Program

FIG. 2 illustrates an embodiment of the present invention of the software components of an installer program 200 (referring to the installer program that may reside in either application 150 or in disk unit 120 as illustrated in FIG. 1). Referring to FIG. 2, installer program 200 may include a middleware installer 201 configured to install middleware applications, such as an application server (application server may refer to software in the Intranet/Internet environment that hosts a variety of language systems used to program database queries and/or general business processing), a relational database management system (for example, DataBase 2 (DB2)) and a protocol used to access a directory listing (for example, Lightweight Directory Access Protocol (LDAP)). It is noted that installer program 200 may include other installers to load different types of applications and that FIG. 2 is illustrative.

Installer program 200 may further include a conflict detection engine 202 configured to determine if there exists any conflicts between an application to be installed and the applications previously installed. Conflict detection engine 202 may be configured to detect the application currently installed and then determine if there is a conflict between these applications and the application to be installed. For example, installer program 200 may be programmed to install an application in a container, which may refer to software used to hold and execute a set of commands or to run other software routines, that contains pre-existing applications. Conflict detection engine 202 may determine if there exists a conflict (referring to incompatibility) between these pre-existing applications and the application to be installed. In another example, installer program 200 may be programmed to install an application in an application server with the latest version, e.g., version 5. The current application server may be an older version, e.g., version 4, that includes a container that contains Java Server Pages (JSPs), Enterprise JavaBeans (EJBs) and JavaBeans. Conflict detection engine 202 may detect a conflict in this case as the applications in the container may not be able to be migrated to a later version of the application server. Also, conflict detection engine 202 may detect a conflict involving the upgrading of the application server. For example, the application server may not be allowed to be upgraded based on the license agreement signed by the owner of the application server.

Any conflicts detected by conflict detection engine 202 may be transmitted to a decision making engine 203. Decision making engine 203 may be configured to transmit information regarding the detected conflict to an autonomic engine 204 configured to determine an appropriate conflict resolution.

In the case of a conflict between an application to be installed in a storage unit, e.g., container, and the applications previously installed in that storage unit, software component 205 of autonomic engine 204 may be configured to determine if the storage unit, e.g., container, can be reused to store the application to be installed along with the pre-existing applications.

In the case of other conflicts detected by conflict detection engine 202, software component 206 of autonomic engine 204 may be configured to determine if there exists an appropriate conflict resolution. For example, software component 206 may determine that the applications in the container may be migrated to a later version of an application server which would resolve the conflict.

If conflicts cannot be automatically cured by autonomic engine 204, then autonomic engine 204 informs decision making engine 203 that there is a conflict that cannot be automatically cured. Decision making engine 203 may be configured to provide the appropriate decision maker, e.g., an administrative user, with an indication that there is conflict or an incompatibility issue with the program to be installed. The decision maker may then be provided with an opportunity to either continue with the installation of the program or to terminate the installation. For example, decision making engine 203 may be configured to transmit such an indication to a user at a terminal 207, e.g., display 138 (FIG. 1). It is noted that terminal 207 may be located in any location whether connected to computer system 100 with installer program 200 or located remotely in a separate building such as in a different state or country.

As stated in the Background Information section, there is a need in the art for allowing multiple decisions to be made by multiple decision makers during software installation. Multiple decision makers may be used to decide multiple decisions during software installation by enabling the developer of the installer program the capability of determining the decisions to be made during the installation process and designating the decision makers to handle each of these decisions. The designated decision makers and the decisions to be made may be listed in a configuration file. The configuration file may later be compiled whose executable code may be embedded within the installer program.

Upon starting the installation of a program by the installer program, decision making engine 203 may be configured to notify the designated decision maker, e.g., user, software program, installer program, upon installer program 200 detecting a decision to be made during the installation process. For example, if the developer had previously determined that the detected decision is to be handled by a user, then decision making engine 203 may be configured to notify the user at terminal 207, e.g., display 138, such as by transmitting a graphical user interface image to terminal 207 which indicates the detected decision to be made, e.g., determine where the install files are to be located. In another example, if the developer had previously determined that the detected decision is to be handled by a software application 208, then decision making engine 203 may be configured to notify software application 208 regarding the detected decision to be made, e.g., determine if the installation files should be configured. In another example, if the developer had previously determined that the detected decision is to be handled by installer program 200, then decision making engine 203 may be configured to notify autonomic engine 204 regarding the detected decision to be made, e.g., determine the directory name that contains the installation files. It is noted that the above indicated decision makers are merely illustrative and that the present invention is not to be limited to using only these specified decision makers. A more detailed description of allowing multiple decisions to be made by multiple decision makers during software installation is provided further below in association with FIG. 3.

The decision made by the decision maker may be transmitted to and received by decision making engine 203. Decision making engine 203 may further be configured to inform a reconfigure unit 209 of installer program 200 of the received decision in order for reconfigure unit 209 to determine if installer program 200 needs to be reconfigured. For example, suppose that a decision maker made the decision as to whether a relational database or an application server is to be installed. Depending on the answer of the decision maker, installer program 200 may have to be reconfigured accordingly in order to install the appropriate application. A more detailed description of determining if installer program 200 needs to be reconfigured based on the decision made by the decision maker is provided below in association with FIG. 3.

FIG. 3—Method for Allowing Multiple Decisions to be Made by Multiple Decision Makers During Software Installation

FIG. 3 is a flowchart of one embodiment of the present invention of a method 300 for allowing multiple decisions to be made by multiple decision makers during software installation.

Referring to FIG. 3, in conjunction with FIGS. 1-2, in step 301, a developer of installer program 200 selects the decisions, e.g., determine where the install files are to be located, to be made during the installation process.

In step 302, the developer of installer program 200 designates the decision makers, e.g., user, software application, installer program 200, to handle each of these decisions in a configuration file. It is noted that the developer may designate different users, e.g., a junior administrator, a senior administrator, to answer separate install questions. It is further noted that the developer may designate different types of decision makers, e.g., software application, installer program 200, users, to answer separate install questions during the installation process.

In step 303, the configuration file is compiled into executable code. In step 304, the executable code is embedded within installer program 200.

In step 305, installer program 200 detects the previously installed applications such as in the storage unit, e.g., container, where the application is to be installed. For example, conflict detection engine 202 may be used by installer program 200 to detect the applications currently installed.

In step 306, installer program 200 determines if there any conflicts between the program to be installed and the applications detected in step 305. For example, conflict detection engine 202 may determine if there are any conflicts between the program to be installed and the applications detected in step 305 as described above.

If installer program 200 determines there is a conflict between the program to be installed and the applications detected in step 305, then, in step 307, installer program 200 determines if an appropriate conflict resolution is available. For example, autonomic engine 204 may determine if an appropriate conflict resolution is available as described above.

If an appropriate conflict resolution is available, then, in step 308, installer program 200 initiates the installation of an application.

If, however, an appropriate conflict resolution is not available, then, in step 309, installer program 200 provides the appropriate decision maker with an option regarding whether to continue with the installation due to the detected conflict. For example, decision making engine 203 may provide the appropriate decision maker, e.g., user, with the option as to whether to continue with the installation due to the detected conflict.

In step 310, the appropriate decision maker determines whether to continue with the installation upon detection of a conflict with no available cure. If the decision maker decides to terminate the installation in step 309, then, in step 311, the installation is terminated. Otherwise, installer program 200 initiates the installation of an application in step 308.

Upon initiating the installation of an application in step 308, installer program 200 encounters a decision to be made, e.g., determine the location to store installation files, during the installation of the application in step 312. As stated above, the developer of installer program 200 may identify particular questions to be presented to a designated decision maker during the installation process in step 301.

In step 313, installer program 200 makes a determination as to whether the encountered decision is to be handled by a user, e.g., administrator. As stated above, the developer of installer program 200 identifies which designated decision makers are to answer questions selected by the developer in step 302.

If the encountered decision is to be handled by a user, then, in step 314, installer program 200 displays a graphical user interface image to the user, e.g., terminal 207, requesting a decision to handle the encountered decision. For example, decision making engine 203 transmits a graphical user interface image to terminal 207 requesting a decision to handle the encountered decision. In step 315, installer program 200 receives the decision from the user.

In step 316, installer program 200 determines if installer program 200 needs to be reconfigured based on the response from the decision maker. For example, decision making engine 203 may inform reconfigure unit 209 of the received decision in order for reconfigure unit 209 to determine if installer program 200 needs to be reconfigured. If installer program 200 determines that installer program 200 needs to be reconfigured, then installer program 200 is reconfigured in step 317. Otherwise, installer program 200 is not reconfigured in step 318.

Referring to steps 317, 318, installer program 200 determines if the installation is complete in step 319. If not, then in step 320, installer program 200 determines if installer program 200 encountered a decision to be made. If installer program 200 has not currently encountered a decision to be made, then, in step 319, installer program 200 determines if the installation is complete.

Referring to step 319, if the installation is complete, then installation is terminated in step 311.

Referring to step 313, if the encountered decision is not to be handled by a user, then, in step 321, installer program 200 determines if the encountered decision is to be handled by a software application. If the encountered decision is to be handled by software, then, in step 322, installer program 200 transmits a request to the designated software application to handle the encountered decision. For example, decision making engine 203 transmits a request to software application 208 requesting a decision to handle the encountered decision. In step 323, installer program 200 receives the decision from software application 208.

Upon receiving the decision from software application 208, installer program 200 determines if installer program 200 needs to be reconfigured based on the response from the decision maker in step 316.

Referring to step 321, if the encountered decision is not to be handled by a software application, then, in step 324, installer program 200 handles the encountered decision automatically. For example, autonomic engine 204 of installer program 200 handles the encountered decision.

Upon handling the encountered decision by installer program 200, installer program 200 determines if installer program 200 needs to be reconfigured based on the response from the decision maker in step 316.

It is noted that other decision makers than indicated above, e.g., user, software application, installer program 200, may be used, e.g., a junior administrator and a senior administrator. It is further noted that method 300 may include other and/or additional steps that, for clarity, are not depicted. It is further noted that method 300 may be executed in a different order presented and that the order presented in the discussion of FIG. 3 is illustrative. It is further noted that certain steps in method 300 may be executed in a substantially simultaneous manner.

Although the method, system and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for allowing multiple decisions to be made by multiple decision makers during software installation comprising the steps of:
selecting decisions to be made during an installation process;
designating decision makers for each selected decision in a configuration file;
compiling said configuration file into executable code; and
embedding said executable code into an installer program.

2. The method as recited in claim 1 further comprising the step of:
detecting one or more previously installed applications.

3. The method as recited in claim 2 further comprising the step of:
determining if there are any conflicts between a program to be installed and said one or more detected applications.

4. The method as recited in claim 3, wherein if there is a conflict between said program to be installed and said one or more detected applications then the method further comprises the step of:
determining an appropriate conflict resolution.

5. The method as recited in claim 3, wherein if there is a conflict between said program to be installed and said one or more detected applications then the method further comprises the step of:
providing a decision maker with an option to continue said installation process.

6. The method as recited in claim 1 further comprising the step of:
encountering a decision to be made.

7. The method as recited in claim 6, wherein if said encountered decision is to be made by a user then the method further comprises the steps of:
displaying a user interface image requesting a decision to handle said encountered decision; and
receiving said requested decision.

8. The method as recited in claim 6, wherein if said encountered decision is to be made by a software program then the method further comprises the steps of:
transmitting a request for a decision to handle said encountered decision; and
receiving said requested decision.

9. The method as recited in claim 6, wherein if said encountered decision is to be made by said installer program then the method further comprises the step of:
handling said encountered decision automatically.

10. The method as recited in claim 6 further comprising the step of:
receiving a response from a decision maker to handle said encountered decision.

11. The method as recited in claim 10 further comprising the step of:
reconfiguring said installer program in response to said received response from said decision maker.

12. A computer program product embodied in a machine readable medium for allowing multiple decisions to be made by multiple decision makers during software installation comprising the programming steps of:
compiling a configuration file into executable code, wherein said configuration file contains designated decision makers for each decision to be made during an installation process; and
embedding said executable code into an installer program.

13. The computer program product as recited in claim 12 further comprising the programming step of:
detecting one or more previously installed applications.

14. The computer program product as recited in claim 13 further comprising the programming step of:
determining if there are any conflicts between a program to be installed and said one or more detected applications.

15. The computer program product as recited in claim 14, wherein if there is a conflict between said program to be installed and said one or more detected applications then the computer program product further comprises the programming step of:
determining an appropriate conflict resolution.

16. The computer program product as recited in claim 14, wherein if there is a conflict between said program to be installed and said one or more detected applications then the computer program product further comprises the programming step of: further comprising the programming step of:
providing a decision maker with an option to continue said installation process.

17. The computer program product as recited in claim 12 further comprising the programming step of:
encountering a decision to be made.

18. The computer program product as recited in claim 17, wherein if said encountered decision is to be made by a user then the computer program product further comprises the programming steps of:
displaying a user interface image requesting a decision to handle said encountered decision; and
receiving said requested decision.

19. The computer program product as recited in claim 17, wherein if said encountered decision is to be made by a software program then the computer program product further comprises the programming steps of:
transmitting a request for a decision to handle said encountered decision; and
receiving said requested decision.

20. The computer program product as recited in claim 17, wherein if said encountered decision is to be made by said installer program then the computer program product further comprises the programming step of:
handling said encountered decision automatically.

21. The computer program product as recited in claim 17 further comprising the programming step of:
receiving a response from a decision maker to handle said encountered decision.

22. The computer program product as recited in claim 21 further comprising the programming step of:
reconfiguring said installer program in response to said received response from said decision maker.

23. A system, comprising:
a processor; and
a memory unit coupled to said processor, wherein said memory unit is operable for storing a computer program for allowing multiple decisions to be made by multiple decision makers during software installation;
wherein said processor, responsive to said computer program, comprises:
circuitry for compiling a configuration file into executable code, wherein said configuration file contains designated decision makers for each decision to be made during an installation process; and
circuitry for embedding said executable code into an installer program.

24. The system as recited in claim 23, wherein said processor further comprises:
circuitry for detecting one or more previously installed applications.

25. The system as recited in claim 24, wherein said processor further comprises:
circuitry for determining if there are any conflicts between a program to be installed and said one or more detected applications.

26. The system as recited in claim 25, wherein if there is a conflict between said program to be installed and said one or more detected applications then said processor further comprises:
circuitry for determining an appropriate conflict resolution.

27. The system as recited in claim 25, wherein if there is a conflict between said program to be installed and said one or more detected applications then said processor further comprises:
circuitry for providing a decision maker with an option to continue said installation process.

28. The system as recited in claim 23, wherein said processor further comprises:
circuitry for encountering a decision to be made.

29. The system as recited in claim 28, wherein if said encountered decision is to be made by a user then said processor further comprises:
circuitry for displaying a user interface image requesting a decision to handle said encountered decision; and
circuitry for receiving said requested decision.

30. The system as recited in claim 28, wherein if said encountered decision is to be made by a software program then said processor further comprises:
circuitry for transmitting a request for a decision to handle said encountered decision; and
circuitry for receiving said requested decision.

31. The system as recited in claim 28, wherein if said encountered decision is to be made by said installer program then said processor further comprises:
circuitry for handling said encountered decision automatically.

32. The system as recited in claim 28, wherein said processor further comprises:
circuitry for receiving a response from a decision maker to handle said encountered decision.

33. The system as recited in claim 32, wherein said processor further comprises:
circuitry for reconfiguring said installer program in response to said received response from said decision maker.
